(19) United States
(12) Patent Application Publication
(10) Pub. No.: US 2005/0093988 A1
(43) Pub. Date: May 5, 2005

(54) Digital camera with automatic mode detection

(76) Inventors: William R. Haas, Fort Collins, CO (US); Kirk S. Tecu, Greeley, CO (US); James S. Voss, Fort Collins, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/700,946

(22) Filed: Nov. 3, 2003

(51) Int. Cl. H04N 5/225; H04N 5/76

(52) U.S. Cl. 348/220.1; 348/231.2

(57) ABSTRACT

A digital camera and automatic mode detection method that eliminates the need for a user to select between video recording mode and still image mode while using the camera. The appropriate mode is automatically selected by the digital camera based upon the length of time its shutter button is depressed.

### TECHNICAL FIELD

The present invention relates generally to digital cameras and methods relating thereto, and more specifically, to a digital camera having automatic mode detection and automatic mode detection method.

### BACKGROUND

The assignee of the present invention develops digital cameras, and the like. Such digital cameras may be used to record still (photographic) images and full motion video images.

Prior solutions to the problem of providing mode detection require pre-selecting the desired image capture mode of the digital camera. This can cause user confusion and can add to the time to required to change modes.

### SUMMARY OF THE INVENTION

An embodiment of the present invention provides a digital camera employing a methodology that eliminates the need for a user to select between video recording mode and still image mode during use of the digital camera. The appropriate mode is automatically selected by the digital camera based upon the length of time the shutter button is depressed. The digital camera includes a processor containing an algorithm that implements the automatic mode detection method.

An exemplary method is as follows. A user presses a shutter button on the digital camera. The digital camera takes a photograph immediately upon detection of the shutter button press. After taking the photograph, the camera automatically switches to video mode and starts recording. If the shutter button remains depressed for more than one second, for example, then the photograph that was taken may be deleted (at the user's option) since the user intends to record video. If the shutter button is released before one second, for example, then the recorded video (which is less than one second) is deleted since the user only intends to capture a still image.

The present invention eliminates the need for the user to pre-select video or still image mode thereby making camera operation simpler and quicker. The problem of quickly and easily switching between still image and video in a digital camera is thus solved by the present invention.

### BRIEF DESCRIPTION OF THE DRAWINGS

The various features and advantages of embodiments of the present invention may be more readily understood with reference to the following detailed description taken in conjunction with the accompanying drawings, wherein like reference numerals designate like structural elements, and in which:

FIGS. 1a and 1b show front and back views, respectively, that illustrate an exemplary embodiment of a digital camera that implements automatic mode detection in accordance with the principles of the present invention; and

FIG. 2 is a flow diagram that illustrates an exemplary automatic mode detection method in accordance with the principles of the present invention.

### DETAILED DESCRIPTION

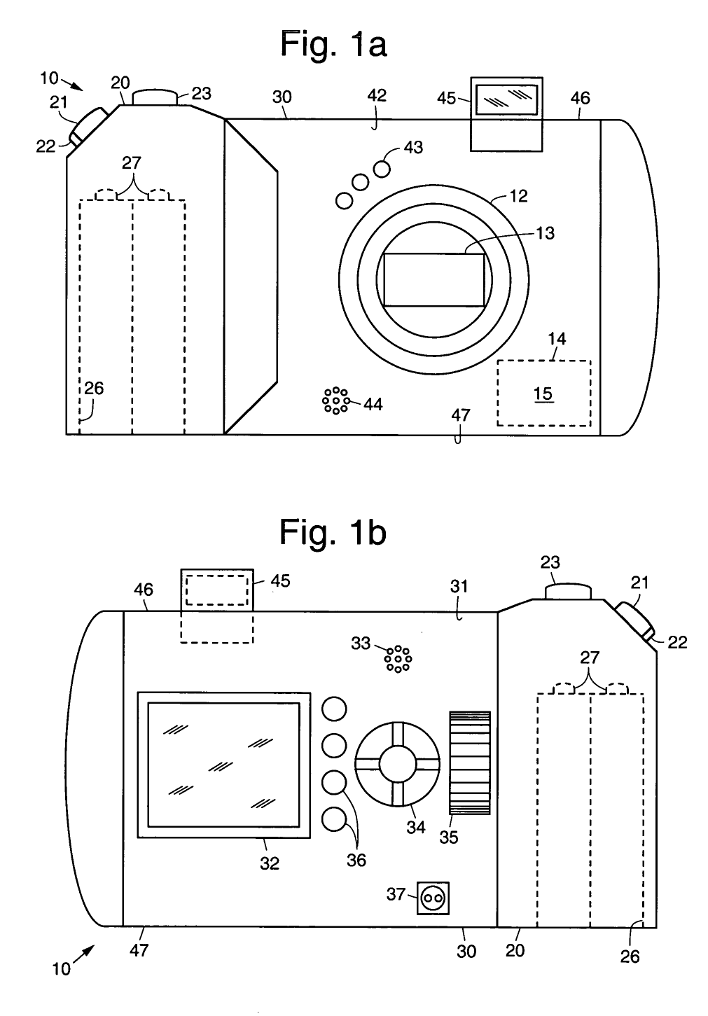

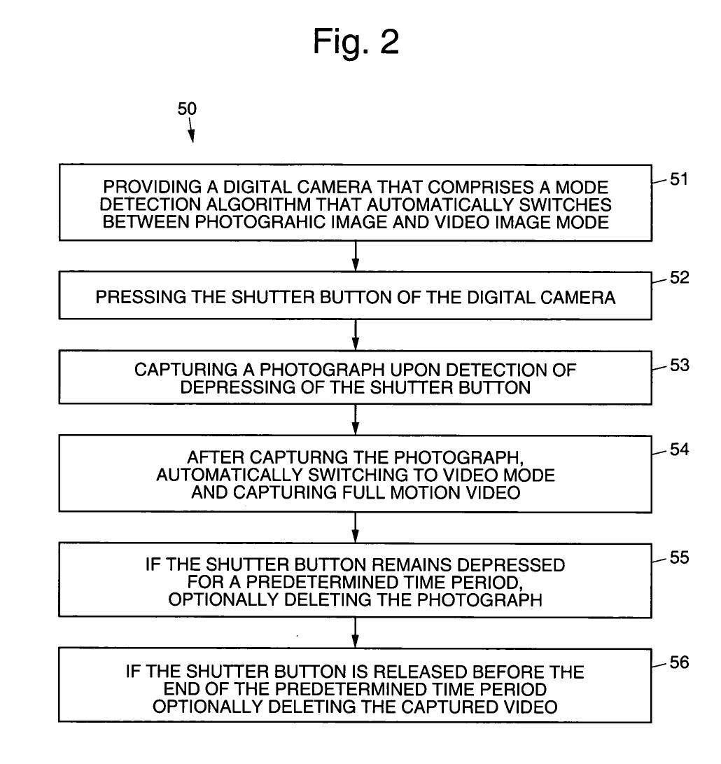

Referring to the drawing figures, FIGS. 1a and 1b show front and back views, respectively, that illustrate an exemplary embodiment of a digital camera 10 in accordance with the principles of the present invention. The exemplary digital camera 10 implements an automatic mode detection method 50 (FIG. 2) in accordance with the principles of the present invention.

The exemplary digital camera 10 comprises a handgrip section 20 and a body section 30. The handgrip section 20 includes a power button 21 having a lock latch 22, a shutter button 23 (or record button 23), and a battery compartment 26 for housing batteries 27. A metering element 43 and microphone 44 are disposed on a front surface 42 of the digital camera 10. A pop-up flash 45 is located adjacent the top surface 46 of the digital camera 10.

As is shown in FIG. 1b, a rear surface 31 of the exemplary digital camera 10 includes a liquid crystal display (LCD) 32, a rear microphone 33, a joystick pad 34, a zoom control dial 35, a plurality of buttons 36 for setting functions of the camera 10 and an output port 37 for downloading images to an external display device or computer, for example.

The digital camera 10 also comprises a lens or imaging optics 12, and an image sensor 13 for receiving images transmitted by the imaging optics 12. A processor 14 is coupled to the image sensor 13 (and other control and input/output components) that implements the present automatic mode detection method 50. The image sensor 13 receives optical images transmitted by the imaging optics 12 and captures digital images thereof. The processor 14 comprises an automatic mode detection algorithm 15 that implements the automatic mode detection method 50 shown in FIG. 2. The automatic mode detection algorithm 15 automatically selects between video recording mode and still image (photographic) mode of the digital camera 10.

FIG. 2 is a flow diagram that illustrates an exemplary automatic mode detection method 50 in accordance with the principles of the present invention. The automatic mode detection method 50 is embodied in the processor 14 of the digital camera 10. Details of the exemplary mode detection method 50 are as follows.

A digital camera is provided 51 that comprises a mode detection algorithm 15 that automatically switches between photographic image and video image mode. A user of the digital camera 10 presses 52 the shutter button 23 (or record button 23) on the camera 10. The camera 10 records 53 a photograph immediately upon detection of pressing of the shutter button 23. After the photograph is taken, the camera 10 (processor 14) automatically switches 54 to video mode and starts recording full motion video. If the shutter button 23 remains depressed for a predetermined time period, such as for more than one second, for example, the photograph may be deleted 55 (at the users option) since the user intends to record video. If the shutter button 23 is released before the end of the predetermined time period, one second, for example, then the recorded video (which is less than one second, for example) is deleted 56 since the user intends to capture a still image or photograph.

Thus, an improved digital camera and automatic mode detection method have been disclosed. It is to be understood that the above-described embodiments are merely illustrative of some of the many specific embodiments that represent applications of the principles of the present invention. Clearly, numerous and other arrangements can be readily devised by those skilled in the art without departing from the scope of the invention.

1. A digital camera comprising:
an image sensor for capturing digital images;
a shutter button; and
a processor coupled to the shutter button and image sensor that implements a mode detection algorithm that automatically switches between still image and video mode.

2. The digital camera recited in claim 1 wherein the mode detection algorithm is operative to:
record a still image upon detection of pressing of the shutter button;
after the still image is recorded, automatically switching to video mode to record video images;
if the shutter button remains depressed for a predetermined time period, optionally deleting the still image; and
if the shutter button is released before the end of the predetermined time period optionally deleting the recorded video images.

3. The digital camera recited in claim 2 wherein the predetermined time period is on the order of one second

4. A method comprising the steps of:
providing a digital camera that comprises a mode detection algorithm that automatically switches between still image and video image mode;
pressing a shutter button on the digital camera;
recording a still image upon detection of pressing of the shutter button;
after the still image is recorded, automatically switching to video mode to record video images;
if the shutter button remains depressed for a predetermined time period, optionally deleting the still image; and
if the shutter button is released before the end of the predetermined time period optionally deleting the recorded video images.

5. The method recited in claim 4 wherein the predetermined time period is on the order of one second
